(19) United States
(12) Patent Application Publication
(10) Pub. No.: US 2005/0284988 A1
(43) Pub. Date: Dec. 29, 2005

(54) Vent pipe support system and method of installation

(76) Inventor: Donald D. Lawver JR., New Philidalphia, NE (US)

Correspondence Address: Kathleen K. Bowen, 311 Hillbrook Dr, Cuyahoga Falls, OH, 44223, US

(21) Appl. No.: 10/878,306

(22) Filed: Jun. 28, 2004

(51) Int. Cl. F16L 3/08

(52) U.S. Cl. 248/65

(57) ABSTRACT

The present invention provides a vent-pipe installation and support system for installing and supporting a vent-pipe system above a joist. This system comprises perpendicular vent-pipe supports for supporting vent-pipes which run generally perpendicular to the joists, and parallel-vent-pipe supports, for supporting vent-pipes which run generally parallel to the joists. The perpendicular-vent-pipe supports comprise a body portion, which is mounted to a joist, and a top portion having a generally C-shaped cut-out. The C-shaped cut-out opens away from the joist, and is sized to fit the vent-pipe, The body portion has graduated markings parallel to the joist top surface, wherein when consecutive graduated markings align with the joist top surface on every other consecutive joists, a supported vent pipe will be at a required grade. The parallel-vent-pipe supports comprise a post having a top, and having a mounting surface, whereby the post mounting surface is mounted to the joist, and a pipe engaging member extending away from the post mounting surface, wherein the pipe engaging member is at the top of the post, and wherein the pipe engaging member is a generally C-shaped cut-out. The C-shaped cut-out opens away from the joist, and is sized to fit the vent-pipe. The post has graduated markings parallel to the joist top surface, wherein when consecutive graduated markings align with the joist top surface on consecutive parallel-vent-pipe supports when the parallel-vent-pipe supports are spaced a predetermined distance apart, a supported parallel-vent-pipe will be at a required grade.

### BACKGROUND

The present invention is in the field of ventilation systems. More specifically this invention relates to a system of installation and support for piping for a ventilation system.

Plumbing in residential and commercial construction needs to be vented. This ventilation pipe needs to exit through the roof of the building, and be installed at a certain grade to allow for drainage. Current methods of installation include using straps, or J-Hooks (a trademark of J-Hook industries, Inc.) disclosed in U.S. Pat. No. 4,409,428 intended for suspending pipe, and modifying them in the field to support pipe. This entails adding extra wood bracing to hang or support these pipes. Often the ventilation pipe support system is created uniquely for the specific building as the ventilation pipes are being installed. Further, modifying these hooks to support the pipes requires tightly locking on to the pipe, which does not allow for expansion and contraction of the pipe.

U.S. Pat. No. 4,254,930, by Warren, discloses a drain pipe hanger for hanging drain pipe. This employs a graduated marking method to help insure the proper grade without measuring every hanger. This however is for hanging pipe, not supporting pipe above joists, which is the preferred method in an attic, and thus for ventilation pipes. Further, this hanger requires that the hanger be installed on the pipe before the pipe is installed, which makes installation complicated.

A further issue is when vent pipes run the same direction as the joists. Prior art mounts these pipes above the joist, leaving no room for walking on the joists during installation.

A vent pipe support and installation system is desired which is designed specifically for ventilation systems, which would support ventilation pipes above the joists, instead of hanging them, which is easy to install, which is offset from the joists for pipe running parallel to the joists to allow for walking on the joists, and which is free floating to allow for expansion and contraction of the pipe due to temperature changes.

### SUMMARY OF THE INVENTION

The present invention provides a vent-pipe installation and support system for installing and supporting a vent-pipe system above a joist. This system comprises perpendicular vent-pipe supports for supporting vent-pipes which run generally perpendicular to the joists, and parallel-vent-pipe supports, for supporting vent-pipes which run generally parallel to the joists. The perpendicular-vent-pipe supports comprise a body portion, which is mounted to a joist, and a top portion having a generally C-shaped cut-out. The C-shaped cut-out opens away from the joist, and is sized to fit the vent-pipe, The body portion has graduated markings parallel to the joist top surface, wherein when consecutive graduated markings align with the joist top surface on every other consecutive joists, a supported vent pipe will be at a required grade. The parallel-vent-pipe supports comprise a post having a top, and having a mounting surface, whereby the post mounting surface is mounted to the joist, and a pipe engaging member extending away from the post mounting surface, wherein the pipe engaging member is at the top of the post, and wherein the pipe engaging member is a generally C-shaped cut-out. The C-shaped cut-out opens away from the joist, and is sized to fit the vent-pipe. The post has graduated markings parallel to the joist top surface, wherein when consecutive graduated markings align with the joist top surface on consecutive parallel-vent-pipe supports when the parallel-vent-pipe supports are spaced a predetermined distance apart, a supported parallel-vent-pipe will be at a required grade.

### BRIEF DESCRIPTION OF THE DRAWINGS

FIG. 1 is an isometric view of a perpendicular-vent-pipe support, supporting a perpendicular vent pipe, according to an aspect of the invention.

FIG. 2 is a front view of a perpendicular-vent-pipe support, with a cut height table, according to an aspect of the invention.

FIG. 3 is an isometric view of perpendicular-vent-pipe supports, supporting a perpendicular vent pipe, according to an aspect of the invention.

FIG. 4 is an isometric view of installed parallel-vent-pipe supports according to an aspect of the invention.

FIG. 5 is an isometric view of a parallel-vent-pipe support according to an aspect of the invention.

FIG. 6 is an isometric view of a parallel-vent-pipe support, supporting a parallel vent pipe, according to an aspect of the invention.

FIG. 7 is an isometric view of a vertical vent pipe cut height according to an aspect of the invention.

FIG. 8 are cut length tables and a Main Horizontal Vent Offset table according to an aspect of the invention

FIG. 9 an isometric view of perpendicular-vent-pipe supports, supporting a perpendicular vent pipe, according to an aspect of the invention.

FIG. 10 is an isometric view of a ventilation support system supporting a system of ventilation pipes according to an aspect of the invention.

FIG. 11 is an isometric view of a top of a vertical vent pipe according to an aspect of the invention.

FIG. 12 is an isometric view of a measurement to a main horizontal pipe according to an aspect of the invention.

FIG. 13 is a cut length table for branch vent pipes according to an aspect of the invention.

FIG. 14 is an isometric view of the perpendicular-vent pipe support installation according to an aspect of the invention.

### DETAILED DESCRIPTION

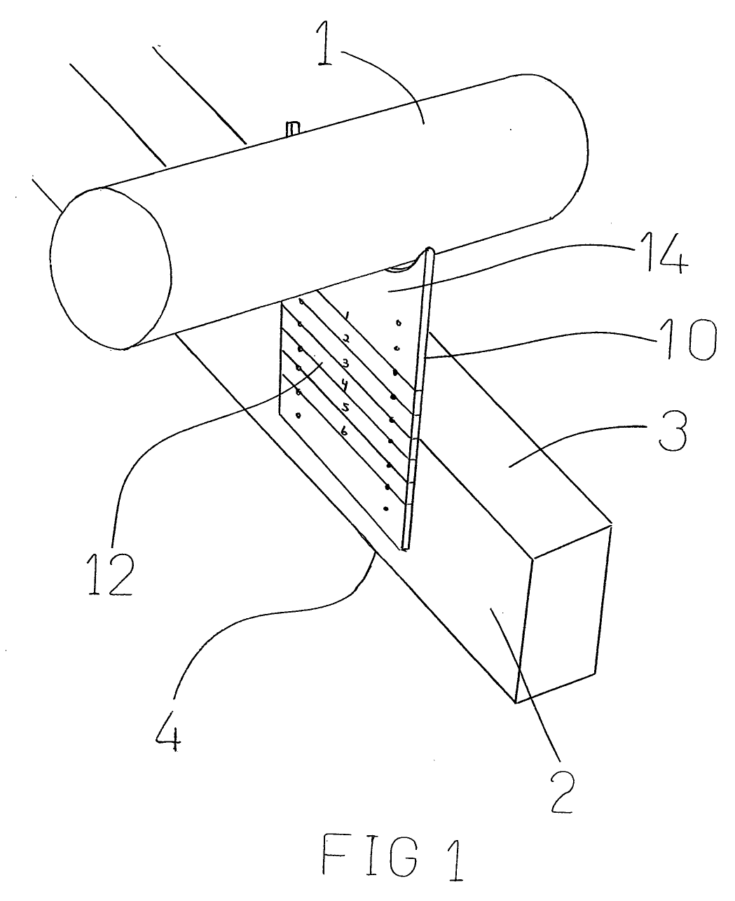

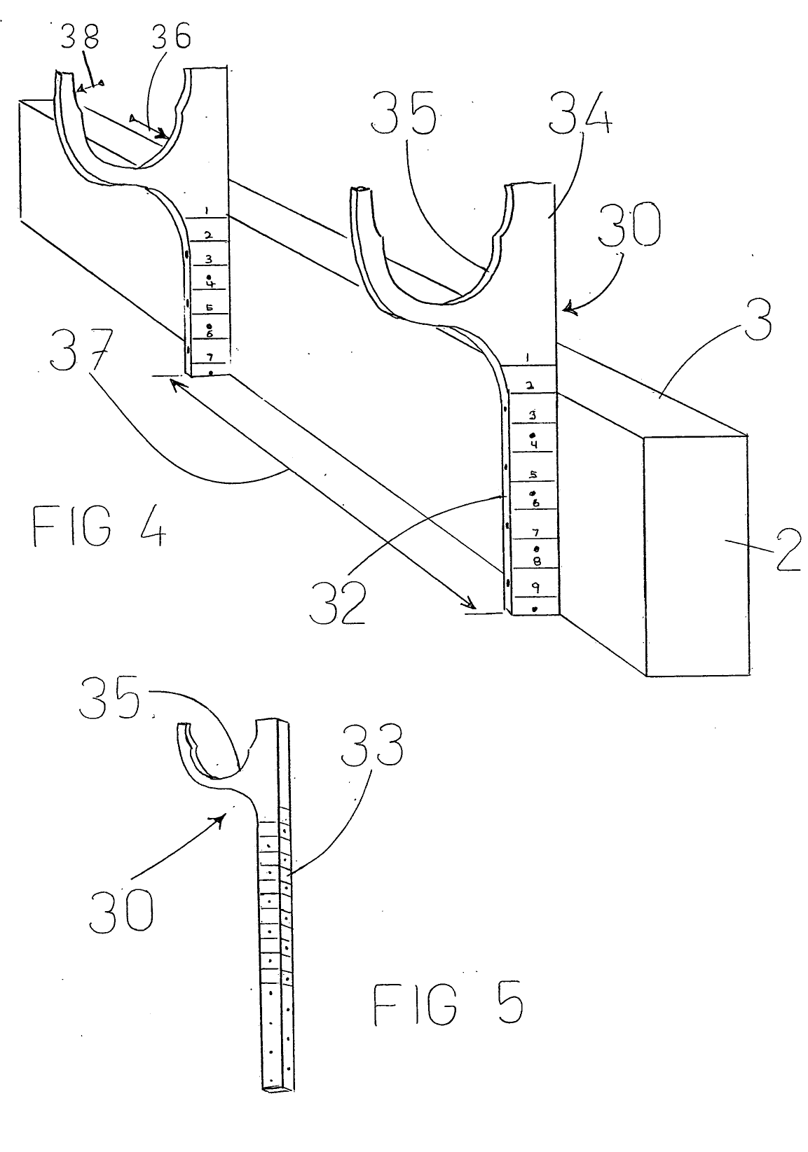

Various aspects of the invention are presented in FIGS. 1-14 which are not drawn to scale and in which like components are numbered alike. Referring now to FIGS. 1-14, according to an aspect of the invention, a vent-pipe support 10 for supporting a vent-pipe 1 above a joist 2, wherein the joists 2 have a top surface 3, and a bottom surface 4, comprises a body portion 12, and a top portion 14. The body portion 12 is mounted to the joist 2. The top portion 14 has a generally C-shaped cut-out 15 which opens away from the joist 2, and which is sized to fit the vent-pipe 1. The cut-out 15 can be sized such that a variety of pipe sizes would fit. The most common application would have a cut-out 15 which could be used for either a 2 inch pipe or a 1½ inch pipe, two standard vent pipe sizes. Prior art designs require hanging the pipe, which requires clipping the pipe into a support, which requires a snug fit. In the present invention, supporting the pipe from underneath does not require a snug fit, and therefore a variety of pipes can be supported with the same vent-pipe support 10. This also allows for expansion and contraction of the pipe due to temperature fluctuations. This type of vent-pipe support is referred to throughout this document as a perpendicular vent-pipe support, as it supports vent-pipes which run approximately perpendicular to the joists.

According to another aspect of the invention, there are graduated markings 13 on the body portion 12. These graduated markings 13 are parallel to the joist top surface 3, and are spaced such that when consecutive graduated markings 13 align with the joist top surface 3 on every second joist 2, a supported perpendicular-vent-pipe 1 will be at a predetermined grade φ. The predetermined grade φ will usually be the grade required by local building codes.

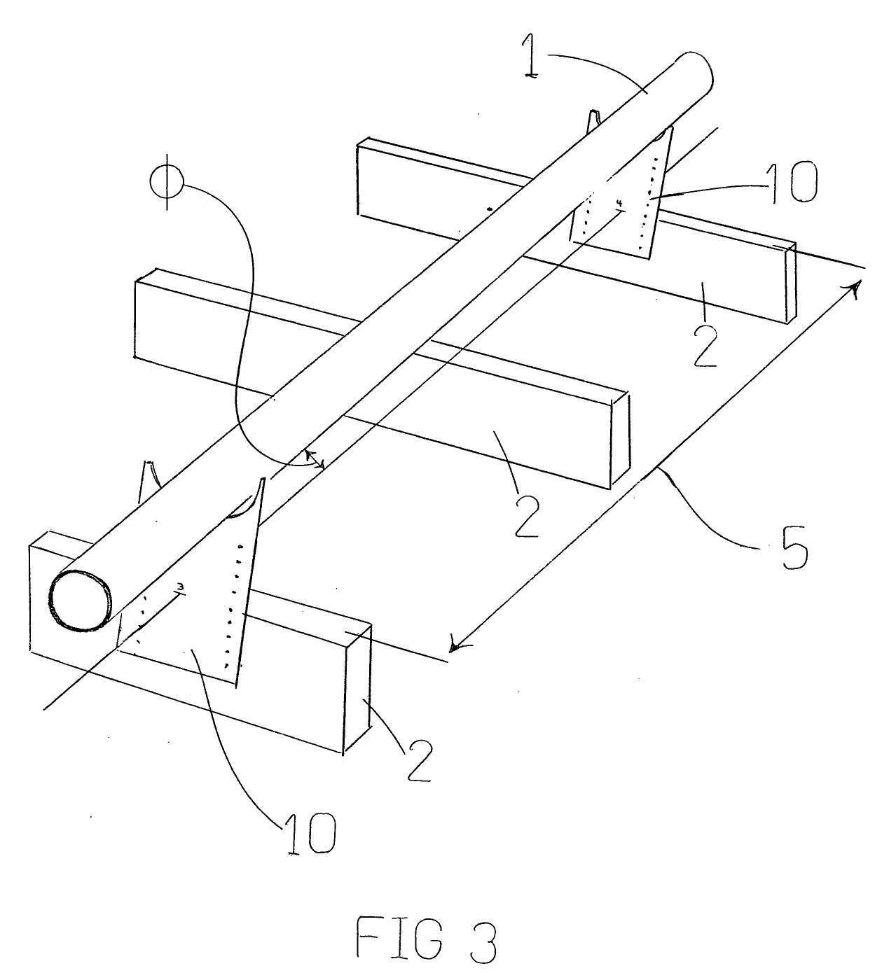

In a preferred embodiment of the invention, the graduated markings 13 are based on a standard 4 foot-to-center joist configuration (see FIG. 3, where the distance 5 is approximately 4 feet).

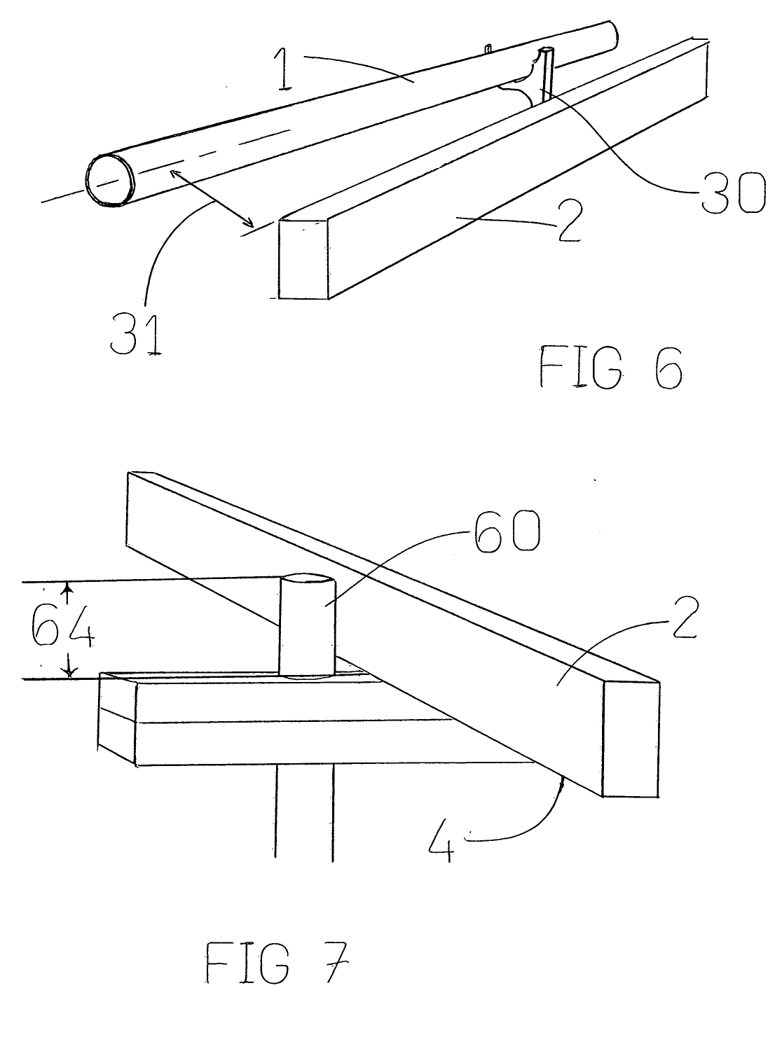

According to another aspect of the invention, a vent-pipe support 30 is for supporting a vent-pipe 1 above a joist 2, and offset 31 from said joist 2 (see FIG. 6) comprises a post 32 and a pipe engaging member 35. The post 32 has a top 34, and a mounting surface 33, whereby the post 32 is mounted to the joist 2 by the mounting surface 33 being mounted to the joist 2. The pipe engaging member 35 extends away from the post mounting surface 33, and is at the post top 34. Further, the pipe engaging member 35 is a generally C-shaped cut-out, wherein the C-shaped cut-out opens away from the joist 2, and is sized to fit the vent-pipe 1. This type of vent-pipe support may also be referred to as a parallel vent-pipe support 30, as it supports vent-pipes which run approximately parallel to the joists. In a preferred embodiment of the invention, the pipe engaging member 35 is stepped, with a smaller radius 36 closer to the joist 2, stepped out to a larger radius 38 away from the joist 2. This could be sized to fit a variety of different pipes. One common configuration could have the smaller radius 36 snugly fit a 1½ inch pipe, and the larger radius 38 snugly fit a 2 inch pipe.

According to a further aspect of the invention, the offset vent-pipe support 30 further comprises graduated markings 13 on the post 32. These graduated markings 13 are parallel to the joist top surface 3, and are spaced such that when consecutive graduated markings 13 align with the joist top surface 3 when the offset vent-pipe supports 30 are spaced a predetermined distance 37 from each other, a supported perpendicular-vent-pipe 1 will be at a predetermined grade φ. The predetermined grade φ will usually be the grade required by local building codes. According to a preferred embodiment of the invention, the predetermined distance 37 is four feet.

According to a further aspect of the invention, a vent-pipe installation and support system 50 for installing and supporting a vent-pipe system 51 above a joist 2, comprises perpendicular vent-pipe supports 10 and parallel vent-pipe supports 30.

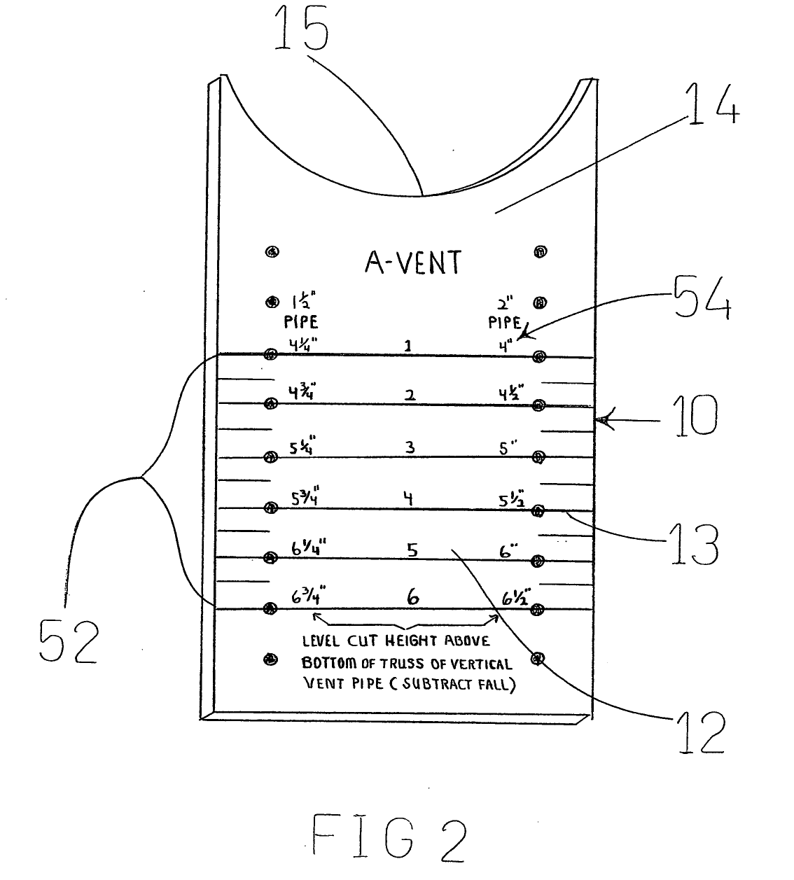

The vent-pipe system 51 is connected to a vertical pipe 60. According to a preferred embodiment of the invention, the vent-pipe installation and support system 50 further comprises a cut-height table 52 correlating the graduated markings 13 to a cut-height 64 the vertical pipe 60 should rise above the joist bottom surface 4. Thus the graduated markings 13 aligned with the joist top surface 3 of the vent-pipe support closest to the vertical pipe 60 correlates to a height 54, wherein the height 54 minus ⅛ inch per foot between the vent-pipe support and the vertical pipe 60 determines the cut-height 64. For example, using the cut-height table 52 shown in FIG. 2, if the vent pipe support closest to the vertical pipe 60 was 2 feet away, and that vent pipe support was aligned with marking number 1, and the pipe was 1½ inch pipe, then the height 54 is 4¼ inches. The cut height 64 would be 4% inches minus (2×⅛) inches, which equals 4 inches.

In a preferred embodiment of the invention, the cut-height table 52 is printed on the perpendicular-vent-pipe supports 10 and the parallel-vent-pipe supports 30. In a further preferred embodiment, there is a cut height table 52 for 1½ inch pipe and a cut height table 52 for 2 inch pipe.

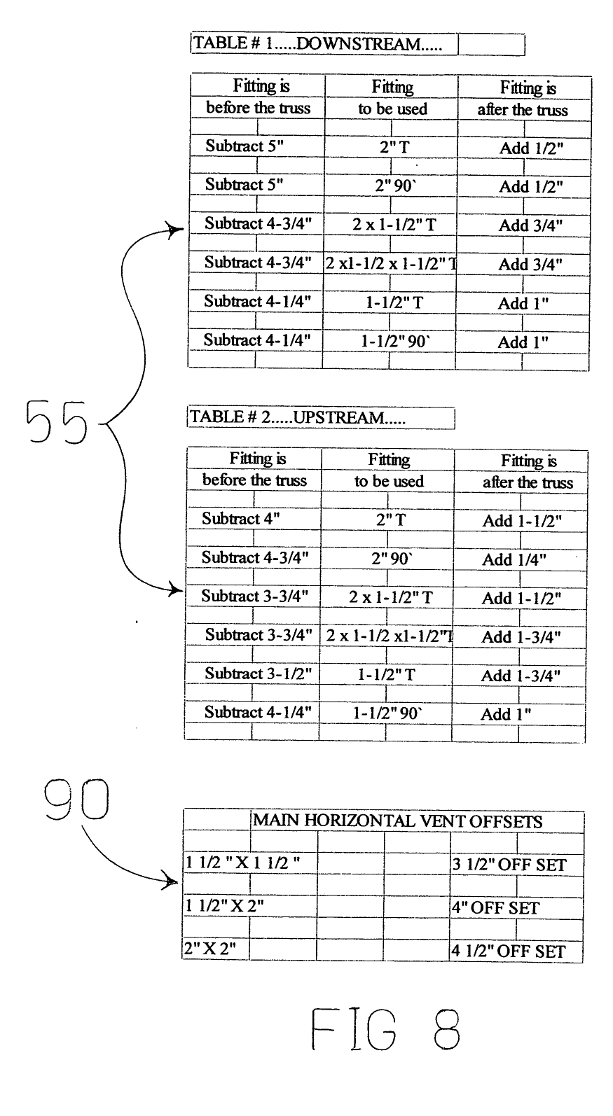

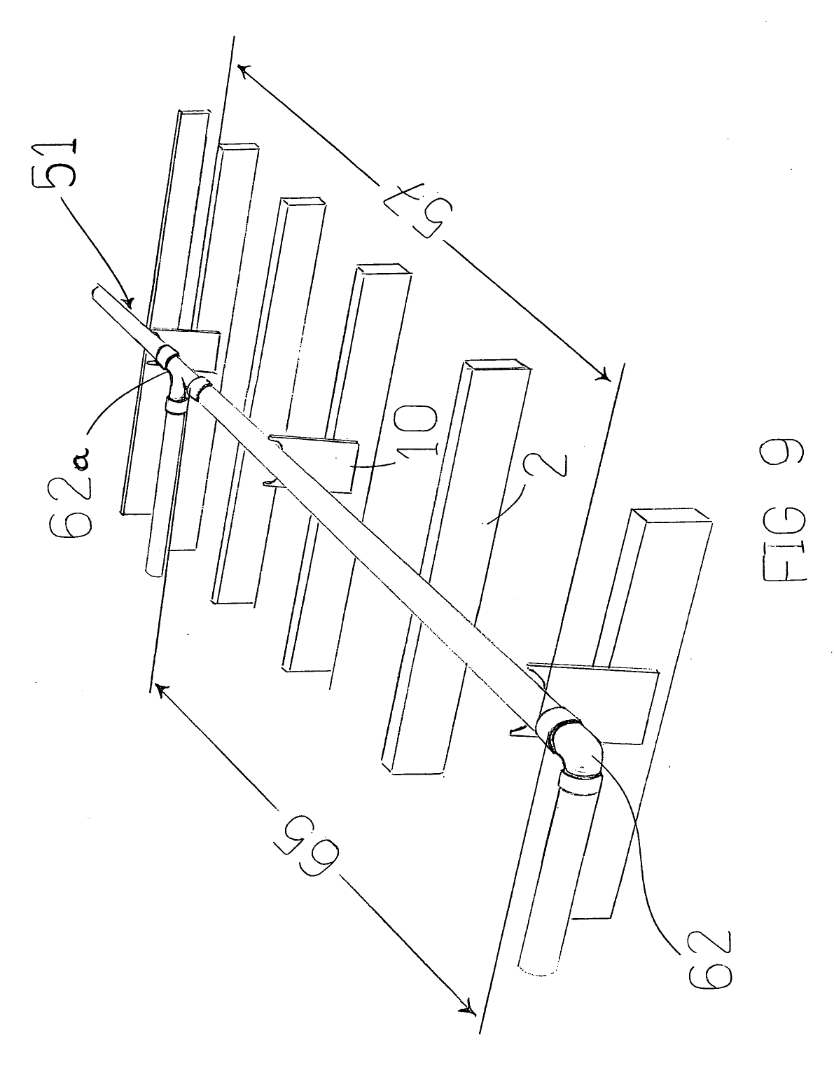

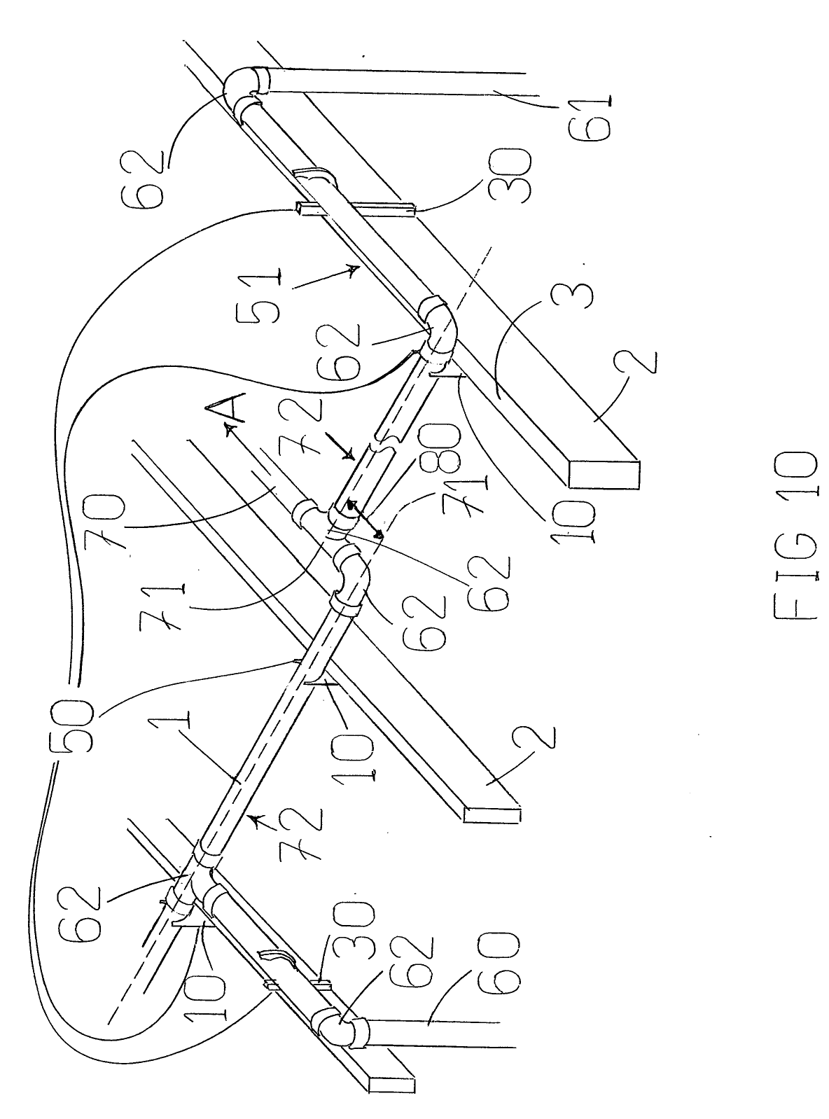

Various portions of vent pipe 1 are connected by fittings 62, according to a further aspect of the invention the vent-pipe installation and support system 50 further comprises a cut length table 55 (see FIG. 8) for determining the cut-length 65 of vent pipe 1 between fittings 62 based on the type of fitting 62 used and the placement of the fitting 62 in relation to the joist 2. This table is used to adjust the measured length 57 from a destination joist to the current fitting. The measurement 57 is measured by hooking a tape measure over the joist nearest the next fitting 62a and measuring to the current fitting 62 (see FIG. 9). This allows for easy one handed measurement, by one installer.

According to another aspect of the invention, a method of installing a vent pipe support system 50 for installing and supporting a vent-pipe system 51 above a joist 2, uses the perpendicular-vent-pipe supports 10, and the parallel-vent-pipe supports 30. First the roof vent terminal 70 is located. This is the terminal that leads out to the main vent out of the roof (in the direction of arrow A in FIG. 10). Then a main horizontal vent position 71 is located, which extends from the roof vent terminal 70, but not towards the roof vent.

Next, the furthest vertical vent 61, that is a vertical vent pipe 60 farthest away from the roof vent terminal 70, is located. Then a parallel-vent-pipe support 30 is mounted four feet away from the furthest vertical vent 61 along the nearest joist 2.

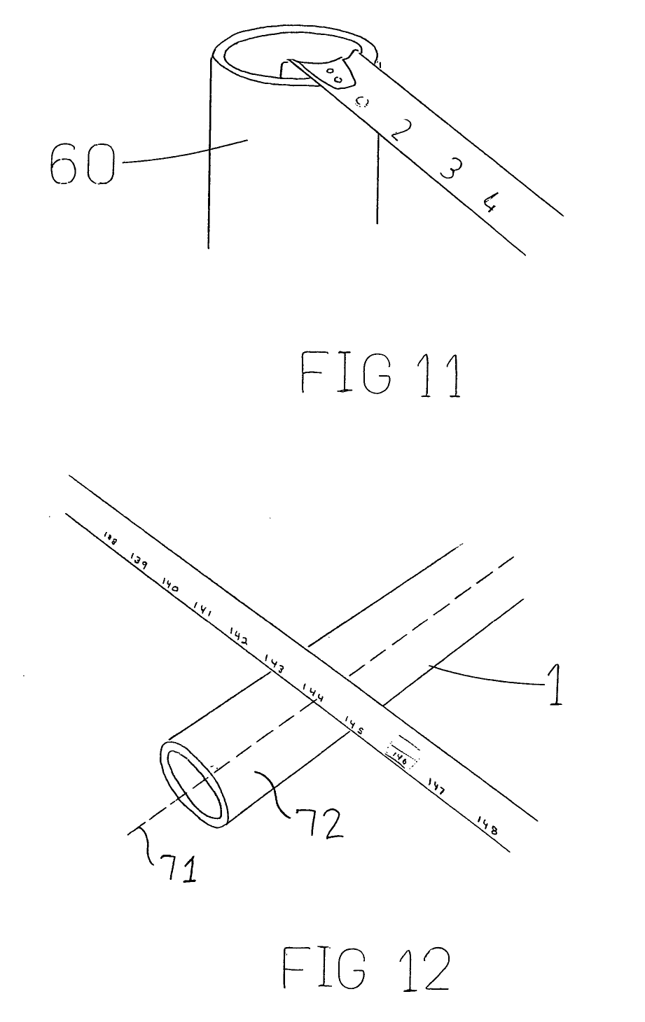

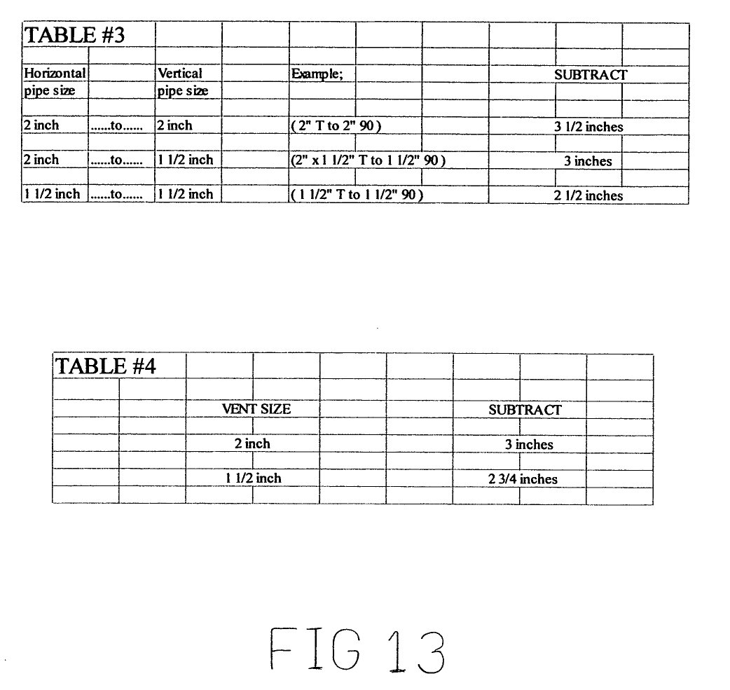

Additional parallel-vent-pipe supports 30 are installed at four foot intervals along the joist 2 until reaching the main horizontal vent position 71, such that consecutive graduated markings align with the joist top surface 3. To measure the length of pipe that will need to be cut from a vertical vent pipe 60 to the main horizontal pipe 72 (which is the perpendicular vent pipe installed at the main horizontal vent position 71) Table 3 is used (see FIG. 13). To use this table, hook a tape measure into the vertical pipe 60 (see FIG. 11), and measure out to the center of the main horizontal pipe 72 that it is being connected to (see FIG. 12). Then find the appropriate pipe size for both the horizontal and vertical pipe on the table, and subtract the amount shown from the measurement just taken. This is an easy way for an individual to determine the cut length for the branch vent pipes (pipes going from the main horizontal pipe 72 to the vertical vent pipes 60).

Then, on the same joist 2 leading to the furthest vertical vent 61, a perpendicular-vent-pipe support 10 is installed at the main horizontal vent position 71. The perpendicular-vent-pipe support 10 is installed such that the graduated marking 13 aligned with the joist top surface 3 is the next consecutive marking after the last parallel vent pipe support 30 mounting mark 13. For instance, if the last parallel vent pipe support 30 was mounted such that the joist top surface 3 aligned with the number 2, then the first perpendicular-vent-pipe support 10 is installed such that the graduated marking 13 aligned with the joist top surface 3 is the number 3.

Then parallel vent pipe supports 30 are installed, spaced four feet from the main horizontal vent position 71 towards any additional vertical vents 60, wherein the parallel vent pipe supports 30 are installed on the joist 2 located closest to these additional vertical vents 60, and are mounted such that the graduated markings 13 aligned with the joist top surface 3 are the previous consecutive mark as compared to the nearest perpendicular vent pipe support 10. For example, if the nearest perpendicular vent pipe support 10 is mounted such that the joist top surface 3 aligned with the number 4, then the first parallel vent pipe support 30 is installed such that the graduated marking 13 aligned with the joist top surface 3 is the number 3.

Additional parallel-vent-pipe supports 30 are installed at four foot intervals along the joist 2 until reaching the additional vertical vent 60, each such that the previous consecutive graduated markings 13 align with the joist top surface 3.

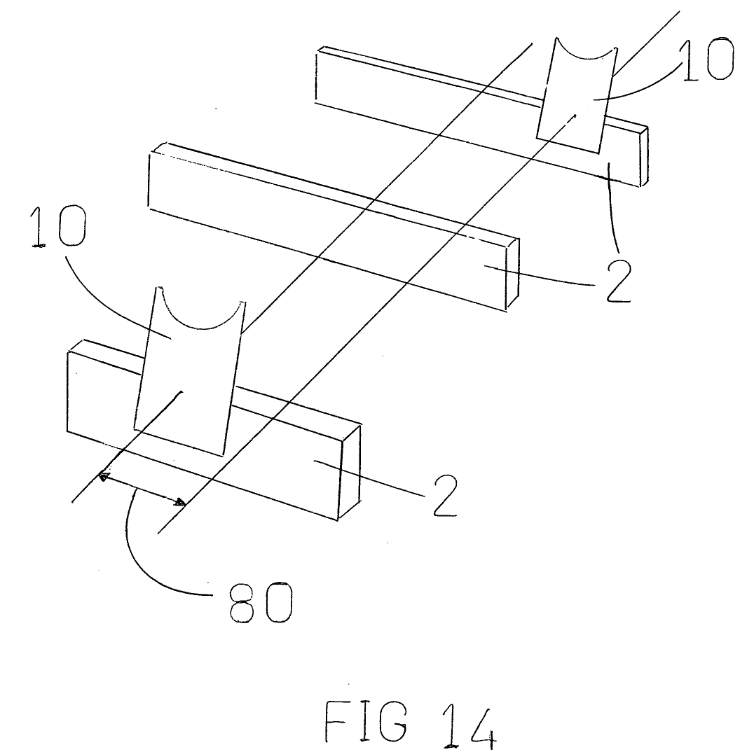

When pipe needs to run in both directions away from the roof vent terminal 70 for the main horizontal vent 72 the main horizontal vent 72 will be offset 80 from one side of the roof vent terminal 70 to the other (see FIG. 10). This offset can be determined using the Main Horizontal Vent Offsets table 90 (see FIG. 8) based on the size of pipe used. This is useful for installing the perpendicular-vent-pipe supports 10 as shown in FIG. 14.

1. A vent-pipe support for supporting a vent-pipe above a joist, wherein the joists have a top surface, comprising:
a body portion, wherein said body portion is mounted to the joist; and,
a top portion having a generally C-shaped cut-out, wherein said C-shaped cut-out opens away from the joist, and wherein said C-shaped cut-out is sized to fit said vent-pipe.

2. The vent-pipe support of claim 1 further comprising graduated markings on said body portion parallel to said joist top surface, wherein when consecutive graduated markings align with the joist top surface on every second joist, a supported perpendicular-vent-pipe will be at a predetermined grade.

3. The vent-pipe support of claim 2 wherein said graduated markings are based on a standard 4 foot-to-center joist configuration.

4. A vent-pipe support for supporting a vent-pipe above a joist, and offset from said joist comprises:
a post having a top, and having a mounting surface, whereby said post mounting surface is mounted to the joist;
a pipe engaging member extending away from said post mounting surface, wherein said pipe engaging member is at said post top, and wherein said pipe engaging member is a generally C-shaped cut-out, wherein said C-shaped cut-out opens away from the joist, and wherein said C-shaped cut-out is sized to fit the vent-pipe.

5. The vent-pipe support of claim 4 further comprising graduated markings on said post parallel to said joist top surface, wherein when consecutive graduated markings align with the joist top surface on consecutive parallel-vent-pipe supports when said parallel-vent-pipe supports are spaced a predetermined distance apart, a supported parallel-vent-pipe will be at a required grade.

6. A vent-pipe installation and support system for installing and supporting a vent-pipe system above a joist, wherein the joists have a top surface, comprising;
perpendicular-vent-pipe supports, for supporting vent-pipes which run generally perpendicular to the joists, wherein said perpendicular-vent-pipe supports comprise a body portion, wherein said body portion is mounted to a joist, and a top portion having a generally C-shaped cut-out, wherein said C-shaped cut-out opens away from the joist, and wherein said C-shaped cut-out is sized to fit said vent-pipe, and further comprising graduated markings on said body portion parallel to said joist top surface, wherein when consecutive graduated markings align with the joist top surface on every second consecutive joists, a supported vent pipe will be at a required grade;
parallel-vent-pipe supports, for supporting vent-pipes which run generally parallel to the joists, wherein said parallel-vent-pipe supports comprise a post having a top, and having a mounting surface, whereby said post mounting surface is mounted to the joist, and a pipe engaging member extending away from said post mounting surface, wherein said pipe engaging member is at said post top, and wherein said pipe engaging member is a generally C-shaped cut-out, wherein said C-shaped cut-out opens away from the joist, and wherein said C-shaped cut-out is sized to fit the vent-pipe and further comprising graduated markings on said post parallel to said joist top surface, wherein when consecutive graduated markings align with the joist top surface on consecutive parallel-vent-pipe supports when said parallel-vent-pipe supports are spaced a predetermined distance apart, a supported parallel-vent-pipe will be at a required grade.

7. The vent-pipe installation and support system of claim 6 wherein the joists have a bottom surface, and wherein the vent-pipe system is connected to a vertical pipe, and further comprising a cut-height table correlating said graduated markings to a height the vertical pipe should rise above the joist bottom surface, such that the graduated marking aligned with the joist top surface of the vent-pipe support closest to the vertical pipe minus ⅛ inch per foot between said vent-pipe support and said vertical pipe determines said height.

8. The vent-pipe installation and support system of claim 7 wherein said cut-height table is printed on said perpendicular-vent-pipe supports and said parallel-vent-pipe supports.

9. The vent-pipe installation and support system of claim 7 wherein there is a cut height table for 1½ inch pipe and a cut height table for 2 inch pipe.

10. The vent-pipe installation and support system of claim 6 wherein various portions of vent pipe are connected by fittings, and further comprising a cut length table for determining the length of vent pipe between fittings based on the type of fitting used and the placement of the fitting in relation to the joist.

11. A method of installing a vent pipe support system for installing and supporting a vent-pipe system above a joist, wherein the joists have a top surface, comprising the steps:
locating roof vent terminal;
locating a main horizontal vent position, which extends from said roof vent terminal;
locate a furthest vertical vent that is a vertical vent farthest away from said roof vent terminal;
installing a parallel-vent-pipe support four feet away from said furthest vertical vent, on a joist closest to said furthest vertical vent, wherein said parallel-vent-pipe support supports vent-pipes which run generally parallel to the joists, wherein said parallel-vent-pipe supports comprise a post having a top, and having a mounting surface, whereby said post mounting surface is mounted to the joist, and a pipe engaging member extending away from said post mounting surface, wherein said pipe engaging member is at said post top, and wherein said pipe engaging member is a generally C-shaped cut-out, wherein said C-shaped cut-out opens away from the joist, and wherein said C-shaped cut-out is sized to fit the vent-pipe and further comprising graduated markings on said post wherein said graduated markings parallel to said joist top surface, wherein when consecutive graduated markings align with the joist top surface on consecutive parallel-vent-pipe supports when said parallel-vent-pipe supports are spaced a predetermined distance apart, a supported parallel-vent-pipe will be at a required grade, wherein said parallel-vent pipe support is installed such that the first consecutive graduated marking align with the joist top surface;
installing additional parallel-vent-pipe supports at four foot intervals along said parallel-vent-pipe mounting joist until reaching said main horizontal vent position, such that consecutive graduated markings align with the joist top surface;
installing a perpendicular-vent-pipe support on said parallel-vent-pipe mounting joist, at said main horizontal vent position, wherein said perpendicular-vent-pipe support supports vent-pipes which run generally perpendicular to the joists, wherein said perpendicular-vent-pipe support comprises a body portion, wherein said body portion is mounted to a joist, and a top portion having a generally C-shaped cut-out, wherein said C-shaped cut-out opens away from the joist, and wherein said C-shaped cut-out is sized to fit said vent-pipe, and further comprising graduated markings on said body portion parallel to said joist top surface, wherein when consecutive graduated markings align with the joist top surface on consecutive joists, a supported vent pipe will be at a required grade, and wherein said perpendicular-vent-pipe support is installed such that the graduated marking aligned with the joist top surface is the next consecutive marking after the last parallel vent pipe support mounting mark;
installing branch vent pipe supports spaced four feet from said main horizontal vent position towards any additional vertical vents, wherein a joist located closest to these additional vertical vents is a branch support joist, and wherein said branch vent pipe supports are installed on said branch support joist, wherein said branch vent pipe supports are of the same construction as the parallel vent pipe supports, and such that said branch vent pipe supports are mounted such that the graduated markings aligned with the branch support joist top surface are the previous consecutive mark as compared to the nearest perpendicular vent pipe support;
installing additional branch-vent-pipe supports at four foot intervals along said branch support joist until reaching the additional vertical vent.

12. The method of claim 11 wherein the joists have a bottom surface, and wherein the vent-pipe system is connected to a vertical pipe, and further comprising a cut-height table correlating said graduated markings to a height the vertical pipe should rise above the joist bottom surface, such that the graduated marking aligned with the joist top surface of the parallel vent-pipe support closest to the vertical pipe correlates to a vertical pipe cut height minus ⅛ inch per foot between said parallel vent-pipe support closest to the vertical pipe and said vertical pipe determines said height and further comprising the step:
measuring the distance in feet between said parallel vent-pipe support closest to the vertical pipe and said vertical pipe;
multiplying this distance by ⅛ inch per foot to get an adjustment measurement;
locating a cut height on said cut-height table which correlates to the graduated marking aligned with the joist top surface of the parallel vent-pipe support closest to the vertical pipe, and subtracting said adjustment measurement from this cut height, resulting in an adjusted cut height; and,
cutting said vertical pipe to said adjusted cut height above said joist bottom surface.

13. The method of claim 12 wherein said cut-height table is printed on said perpendicular-vent-pipe supports.

14. The method of claim 12 wherein there is a cut height table for 1½ inch pipe and a cut height table for 2 inch pipe.
